(19) United States
(12) Patent Application Publication
(10) Pub. No.: US 2006/0113959 A1
(43) Pub. Date: Jun. 1, 2006

(54) Rechargeable battery life judging method

(75) Inventor: Hisanori Honma, Takasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/287,211

(22) Filed: Nov. 28, 2005

(30) Foreign Application Priority Data
Nov. 29, 2004 (JP) 2004-344734

(51) Int. Cl. H02J 7/00

(52) U.S. Cl. 320/128

(57) ABSTRACT

In a method of judging the life of a rechargeable battery, the rechargeable battery being used while charge and discharge are repeatedly performed therefor, an internal resistance (R) is measured in a state in which a remaining power of the rechargeable battery during a charge phase of the rechargeable battery becomes in the range of 30 to 85% of the capacity in a full charge state, and the life of the rechargeable battery is judged based on a change of the value of the internal resistance (R) with passage of time.

### BACKGROUND OF THE INVENTION

1. Field of the Invention

The present invention relates to a rechargeable battery life judging method which is capable of precisely judging the life of a rechargeable battery such as a nickel-hydride metale battery which is used as a backup power source for a computer for example.

2. Description of the Related Art

A power of a rechargeable battery such as a nickel-hydride metale battery which is used as a backup power source for a computer for example is not only consumed along with a power source backup operation during a power failure phase, but also consumed along with self-discharge of the rechargeable battery itself or an operation of an internal circuit in a battery pack. For this reason, when a remaining power of the rechargeable battery is reduced along with discharge (power consumption), a function as the backup power source is maintained by recharging the rechargeable battery with electricity.

Now, it cannot be denied that in the rechargeable battery, the charge and discharge are repeatedly performed, thereby gradually degrading the life of the battery. Then, heretofore, as introduced in Japanese Unexamined Patent Publication No. Hei 11-7985 for example, the life of the battery has been judged based on a change in value of an internal resistance of the rechargeable battery.

By the way, in the above publication, since the value of the internal resistance of the rechargeable battery changes in accordance with the battery temperature, a battery temperature is detected and the value of the internal resistance of the rechargeable battery is corrected in accordance with the detected battery temperature. The value of the internal resistance which is corrected in accordance with the detected battery temperature is compared with a value of an internal resistance, when the life terminates (when the battery performance is degraded), which is previously obtained at a reference temperature, thereby judging the life of the rechargeable battery.

However, the applicant of this application has performed various experiments using a nickel-hydride metale battery which is a typical rechargeable battery, and as a result, has found out that even when the internal resistance is used which is corrected in accordance with the detected battery temperature, the life of the rechargeable battery cannot necessarily be judged properly.

### SUMMARY OF THE INVENTION

The present invention has been made in order to solve the problem as described above, and it is therefore an object of the present invention to provide a rechargeable battery life judging method which is capable of suitably measuring an internal resistance of a rechargeable battery to suitably judge the life of the rechargeable battery.

In order to attain the above-mentioned object, according to the present invention, there is provide a method of judging the life of a rechargeable battery, the rechargeable battery being used while charge and discharge are repeatedly performed therefor, in which when the rechargeable battery is charged with electricity, an internal resistance of the rechargeable battery is measured only in a state in which a remaining power of the rechargeable battery has a predetermined capacity, and change of a value of the internal resistance with passage of time is obtained, thereby judging the life of the rechargeable battery based on the change of the value of the internal resistance with passage of time.

Preferably, when the remaining power of the rechargeable battery during a full-charge phase is set as 100%, the internal resistance of the rechargeable battery is measured in a state in which the remaining power of the rechargeable battery during the charge phase is equal to or larger than 30%, but equal to or smaller than 93%. More preferably, the internal resistance of the rechargeable battery is measured in a state in which the remaining power of the rechargeable battery during the charge phase is equal to or larger than 30%, but equal to or smaller than 85%.

In the present invention, since the internal resistance of the rechargeable battery is measured while the rechargeable battery is charged with electricity under the condition of the above-mentioned remaining power, the value of the internal resistance of the rechargeable battery can be stably and precisely obtained irrespective of the charging state of the rechargeable battery. Then, the life of the rechargeable battery can be precisely judged by examining the change of the value of the internal resistance with passage of time which is stably and precisely obtained in such a manner.

### BRIEF DESCRIPTION OF THE DRAWINGS

FIG. 1 is a schematic circuit block diagram of a battery pack (backup power source unit) which is realized by applying a rechargeable battery life judging method according to the present invention;

FIG. 2 is an equivalent circuit diagram explaining a relationship between an internal resistance R and a terminal voltage V of the rechargeable battery;

FIG. 3 is a flow chart showing an example of a schematically executing procedure of the rechargeable battery life judging method according to the present invention;

FIG. 4 is a graphical representation showing changes in values of the internal resistances R of four sample secondary batteries accompanying a charge and discharge cycle; and

FIG. 5 is a graphical representation showing changes in values of the internal resistance R, a charging voltage V, and a rechargeable battery temperature T during a charge phase.

### DETAILED DECRIPTION OF THE INVENTION

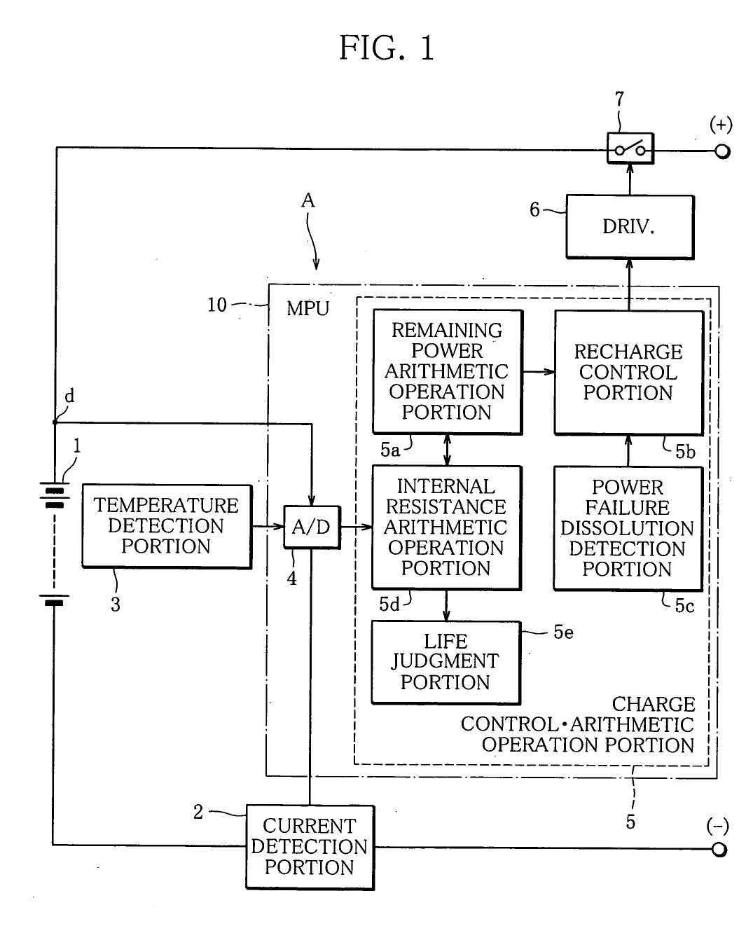

A preferred embodiment of a rechargeable battery life measuring method according to the present invention will hereinafter be described in detail with reference to FIGS. 1 to 5.

FIG. 1 shows a schematic configuration of a battery pack A as a backup power source (=uninterruptible power sopply) for a computer which is configured by applying a rechargeable battery life judging method according to the present invention.

The battery pack A is used in a state of being connected to an internal power source for a computer such as a server. During a steady state phase, a rechargeable battery 1 of the battery pack A is charged with electricity by the internal power source. On the other hand, during a power failure phase, the battery pack A has a part for discharging a power energy accumulated in the rechargeable battery 1 to supply a power to the computer.

The battery pack A schematically includes the rechargeable battery 1 such as a nickel-hydride metale battery, a current detection portion 2 having a resistor or the like for detecting a current when the rechargeable battery 1 is charged with electricity or the electric charges accumulated in the rechargeable battery 1 are discharged, and a microprocessor unit (hereinafter referred to as “an MPU”) 10 for monitoring the charge and discharge of the rechargeable battery 1 and for controlling the charge and discharge of the rechargeable battery 1. In addition, a temperature detection portion 3 which includes a thermistor and which is disposed in close proximity in the rechargeable battery 1 (e.g., a battery with 3200 mAh capacity in which 36 battery cells are connected in series with one another) is provided within the battery pack A.

An analog voltage representing a terminal voltage (measured at a node d) V of the rechargeable battery 1, an analog voltage representing a charging/discharging current I detected by the current detection portion 2, and an analog voltage representing a battery temperature T detected by the temperature detection portion 3 are input to the MPU 10. That is, these analog signals are digitally converted in an A/D conversion portion 4 and changed into an actual voltage value (mV), an actual current value (mA), and the like. The actual voltage value, the actual current value and the like are then fetched in the MPU 10. The output signal from the A/D conversion portion 4 is input to a charge control•arithmetic operation portion 5 which will be described later. That is, the output signal is subjected to processing for arithmetic operation, comparison, judgment and the like in the charge control•arithmetic operation portion 5 and used for the charge/discharge control for the rechargeable battery 1. A driver 6 is then driven by using an output signal from the charge control-arithmetic operation portion 5, so that a control element 7 which is constituted by a switching transistor or the like and which is inserted in series into a charge/discharge path for the rechargeable battery 1 is subjected to turn-on/off control.

In addition, the charge control•arithmetic operation portion 5, for example, accumulates the charging/discharging current I of the rechargeable battery 1 and subjects the remaining power of the rechargeable battery 1 to the arithmetic operation processing by utilizing the well-known technology. Also, the charge control-arithmetic operation portion 5 stores various data in a memory (not shown).

In addition, the charge control-arithmetic operation portion 5 detects a change ΔV in battery voltage V (=reduction in voltage) or detects a full charge state of the rechargeable battery 1 by utilizing the remaining power obtained in the arithmetic operation.

More specifically, the charge control•arithmetic operation portion 5 functionally includes a remaining power arithmetic operation portion 5a for obtaining a remaining power of the rechargeable battery 1 and a recharge control portion 5b for, when a capacity of the rechargeable battery 1 is reduced from a full charge capacity to a certain degree of a remaining power, driving the driver 6 to recharge the rechargeable battery 1 with electricity in accordance with an output signal from the remaining power arithmetic operation portion 5a. Furthermore, the recharge control portion 5b includes a function as well of, when a power failure dissolution detection portion 5c detects dissolution of a power failure state (when a power source is restored) while the rechargeable battery 1 supplies a power to a computer during the power failure phase, starting to recharge the rechargeable battery 1 with electricity in response to the detection of the dissolution.

Also, the charge control•arithmetic operation portion 5 further includes an internal resistance arithmetic operation portion 5d for calculating a value of an internal resistance R of the rechargeable battery 1 as will be described later, and a life judgment portion 5e for judging a life of the rechargeable battery 1 in accordance with the calculated value of the internal resistance R. Be noted that only when during the charge phase of the rechargeable battery 1, the remaining power of the rechargeable battery 1 which is obtained by the remaining power arithmetic operation portion 5a, for example, is in the range of 30 to 85% of the power in the full charge state, the internal resistance arithmetic operation portion 5d calculates the value of the internal resistance R of the rechargeable battery 1 based on the terminal voltage V, the charging current I, etc. of the rechargeable battery 1.

Now, since the battery pack A is utilized as the backup power source during the power failure phase, normally, the rechargeable battery 1 is kept in a state near the full charge state. In addition, since the frequency of occurrence of the power failure is generally very low, the reduction of the remaining power of the rechargeable battery 1 is exclusively caused by the self-discharge of the rechargeable battery 1 itself, and the power consumption of the MPU 10 or the like within the battery pack A.

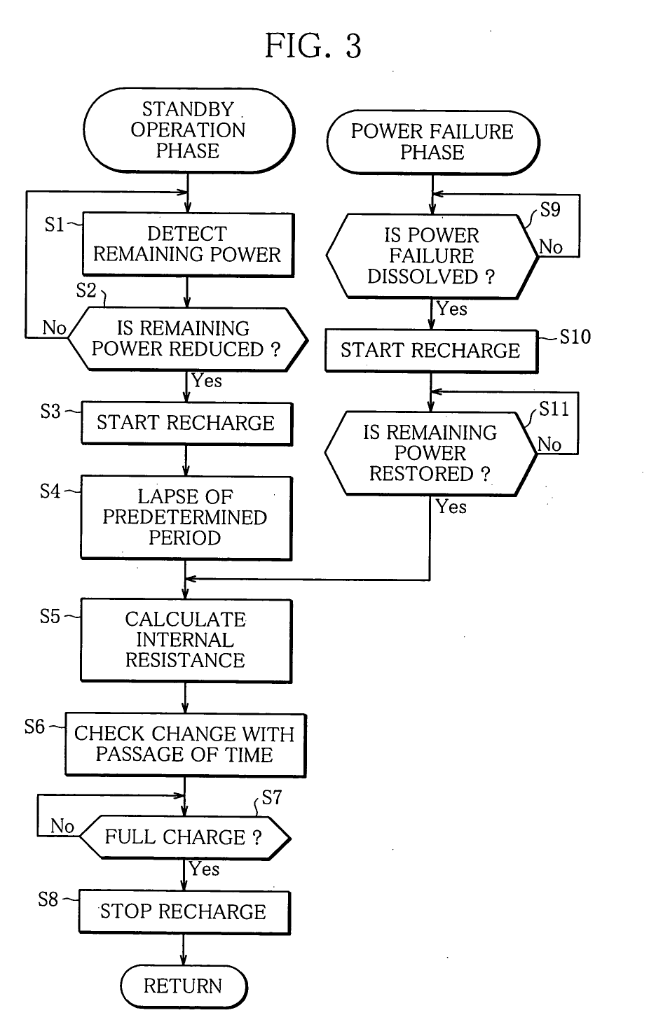

Then, in this embodiment, for example, calculation of the value of the internal resistance R of the rechargeable battery 1 and judgment of the life thereof are made in accordance with a processing procedure shown in FIG. 3. That is, the charge control-arithmetic operation portion 5 regularly monitors the remaining power of the rechargeable battery 1 [Step S1]. That is, when the remaining power of the rechargeable battery 1 is reduced to a preset remaining capacity due to the self-discharge, the power consumption of the internal circuit, and the like [Step S2], the charge control•arithmetic operation portion 5 starts to recharge the rechargeable battery 1 with electricity (the pulse-charge the rechargeable battery 1 with electricity in this embodiment) [Step S3]. Incidentally, the remaining power may be obtained by subtracting a consumed power capacity obtained as an accumulated value of a discharging current value per predetermined time from the full charge capacity. Alternatively, the remaining power may also be obtained from a relationship between the previously obtained battery capacity and the battery voltage V. Be noted that the ratio of the remaining power when the start of the recharge is controlled to the full charge capacity is preferably equal to or larger than 75%, but equal to or smaller than 95%, and more preferably equal to or larger than 80%, but equal to or smaller than 90%. In this embodiment, the remaining power when the recharge is started is set to 90%.

The recharge of the rechargeable battery 1, for example, is performed by utilizing the pulse charge method using a given current of about 0.1 C to about 0.5 C for a cycle in which an on period is about 7 seconds and an off period is about 3 seconds. After a lapse of a predetermined time after the pulse charge for the rechargeable battery 1 is started [Step S4], the internal resistance R of the rechargeable battery 1 is measured [Step S5], and thus the change of the value of the internal resistance R with passage of time is examined to judge the life of the rechargeable battery 1 [Step S6]. At the same time, it is monitored whether or not the rechargeable battery 1 reaches the full charge state along with the recharge [Step S7]. When it is monitored in Step S7 that the rechargeable battery 1 reaches the full charge state, the recharge is stopped [Step S8].

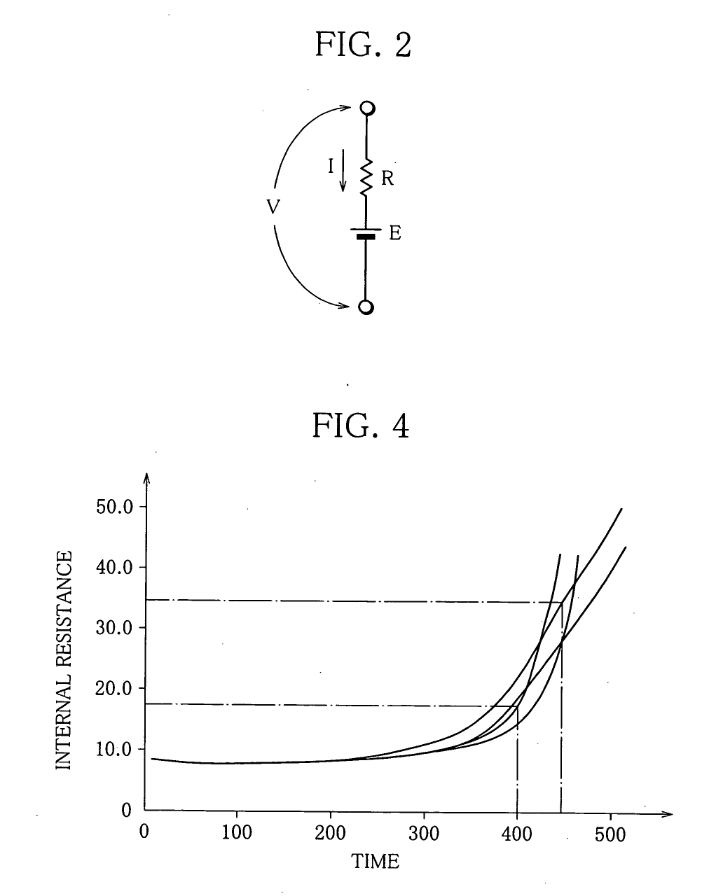

Here, a method of calculating the value of the interval resistance R during the pulse charge phase will be briefly described. Each of elemental batteries (battery cells) constituting the rechargeable battery 1, as shown in an equivalent circuit of FIG. 2, can be expressed in the form of a series circuit of an element for generating an electromotive force E which is an original power of the rechargeable battery 1, and the internal resistance R. Thus, since the charging current I is caused to flow through the rechargeable battery 1 during an on phase of the pulse charge, the following relationship is established between the electromotive force E, the internal resistance R and the charging current I, and a terminal voltage Von of the rechargeable battery 1:
Von(measured voltage)=R(internal resistance)×I(measured current)+E(electromotive voltage) (Expression 1)

In addition, since no charging current I is caused to flow through the rechargeable battery 1 during an off phase of the pulse charge, a terminal voltage Voff of the rechargeable battery 1 is expressed by Expression 2:
Voff(measured voltage)=E(electromotive voltage) (Expression 2)

Consequently, when the terminal voltage Von in the on phase of the pulse charge, and the terminal voltage Voff in the off phase of the pulse charge are individually obtained, the value of the internal resistance R of the rechargeable battery 1 can be calculated as follows from a relationship between Expression 1 and Expression 2:
R=(Von−Voff)/I
It goes without saying that the measurement of the internal resistance R may be performed by utilizing any other suitable method than that method. Such calculation of the value of the internal resistance R, as described above, is performed by detecting the terminal voltages Von and Voff at a time point when the internal state of the rechargeable battery 1 is chemically stabilized after a lapse of a period of 1 to 3 minutes (preferably 2 minutes) after the pulse charge is started. Hence, the stable value of the internal resistance R can be precisely obtained.

By the way, when the pulse charge is performed over 2 minutes under the above-mentioned charging condition, the battery capacity which is obtained by charging the rechargeable battery 1 with the charging current I of 0.1 C corresponds to 0.23% of the full charge capacity. Also, when the charging current I of 0.5 C is used, the battery capacity in this case corresponds to 1.17% of the full charge capacity. Consequently, the measurement of the internal resistance R is performed with the remaining power which is nearly identical to that of the rechargeable battery 1 when the recharge is started.

Now, after the power energy which remains in the secondary buttery 1 after being discharged during the power failure phase is supplied to the computer, normally, the remaining power of the rechargeable battery 1 becomes equal to or less than that as the origin of the start of the recharge. Thereafter, when the power failure is dissolved and the supply of the commercial power is started, the charge control•arithmetic operation portion 5 detects the dissolution of the power failure [Step S9], and starts the charge of the rechargeable battery 1 by using the same pulse charge as that of the foregoing [Step S10]. In this case, however, since the remaining power of the rechargeable battery 1 is largely reduced as described above, the charge control•arithmetic operation portion 5 waits until the remaining power increases to some degree [Step S11], and measures the internal resistance R of the rechargeable battery 1 at a time point when the remaining power is restored [Step S5]. The ratio of the remaining power when the state of the rechargeable battery 1 is regarded as being restored to some degree to the full charge capacity is preferably equal to or larger than 75%, but equal to or smaller than 95%, and more preferably equal to or larger than 80%, but equal to or smaller than 90%. In this embodiment, when the remaining power becomes 90%, the state of the rechargeable battery 1 is regarded as being restored.

On the other hand, the charge control-arithmetic operation portion 5 stores, from a time point when the battery pack A is started to be used, the values of the internal resistance R successively obtained in the manner as described above as a history of the internal resistance R. Thus, the charge control•arithmetic operation portion 5 compares the value of the internal resistance R at a time point of use of the rechargeable battery 1 with the internal resistance value as a comparative reference obtained from the history to judge the life of the rechargeable battery 1.

More specifically, the charge control•arithmetic operation portion 5 compares the value of the internal resistance R obtained at that time point (current time point) of use of the rechargeable battery 1 with an initial value Rint of the internal resistance R which is obtained at the time point of use of the rechargeable battery 1 to be stored, preferably with a value Rref of the internal resistance R which is obtained after a lapse of a given period from a time point of the initial use. When the value of the internal resistance R obtained at the current time is 2 or more times as large as such an initial value Rint (Rref) of the internal resistance R, normally, the capacity at which the electric charges of the rechargeable battery 1 can be discharged is reduced to about ¾ of the initial capacity. As a result, it is understood that the performance of the rechargeable battery 1 is degraded and the battery life is approached all the more since the value of the internal resistance R becomes higher than the initial value of the internal resistance R.

In the battery pack A of this embodiment, in a state in which it is detected in the manner as described above that the life of the rechargeable battery 1 is approached, a signal for informing the computer side of the preparation for replacement of the second battery 1 is output to cause the computer side to recognize and display this fact. In addition, when the value of the internal resistance R further increases so that it becomes 4 or more times as large as the initial value Rint of the internal resistance R and the dischargeable capacity becomes about half the initial capacity, this state is judged to nearly get to the battery life, and the signal for informing the computer side of the preparation for replacement of the second battery 1 is output to cause the computer side to recognize and display this fact.

FIG. 4 shows results of examining changes in values of the internal resistances R accompanying progress of a charge cycle in the rechargeable battery 1. Thus, cyclic characteristics of values of internal resistances R of four kinds of sample secondary batteries 1 are shown in FIG. 4. These four characteristic curves show changes in values of the internal resistances R having the same tendency. In particular, when the number of repetitive cycles of the charge and discharge exceeds 350, the internal resistances R increase. When the number of repetitive cycles falls in the range of about 375 to about 420, the values of the internal resistances R become 2 or more times as large as their initial values. Also, when the number of repetitive cycles falls in the range of about 440 to about 480, the values of the internal resistances R become 4 or more times as large as their initial values.

Furthermore, in the experiments, each of the sample secondary batteries 1 was pulse-charged with electricity by using the charging current I of 0.1 C, and the full charge thereof was performed by utilizing a −ΔV method. Thus, these experiments were performed by repeatedly carrying out the charge and discharge cycle such that after a pause for 15 minutes after detection of the full charge capacities, the values of the internal resistances R were measured, and after the electric charges of the sample secondary batteries 1 were discharged with a current of 15 A each and the sample secondary batteries 1 were paused for 30 minutes, the sample secondary batteries 1 were charged with electricity again.

It was confirmed from the experimental results that in the case where the charge and discharge were repeatedly performed for the sample secondary batteries 1, when the number of times of repetition of the charge and discharge exceeded a certain value, the values of the internal resistances R of the sample secondary batteries 1 abruptly increased up to 2 times and then 4 times as large as their initial values. Also, it was confirmed that as the values of the internal resistances R increases, the dischargeable capacities of the sample secondary batteries 1 are reduced, the battery performance is degraded, and the life of the sample secondary batteries 1 terminate.

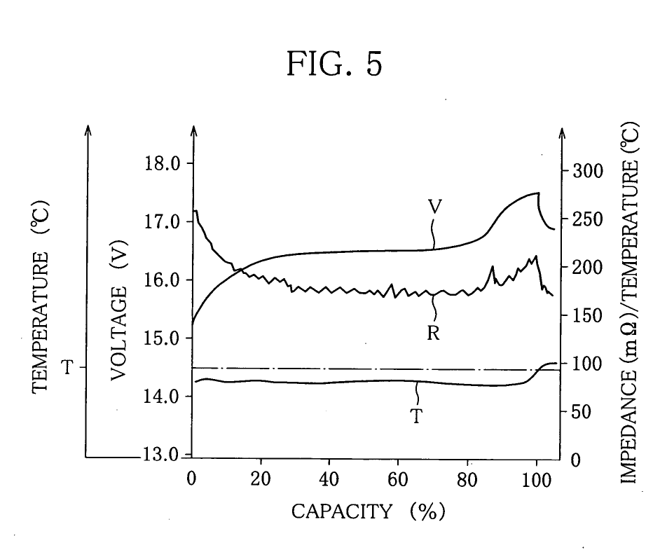

Here, a description will be given with respect to a range of the battery capacity which is preferable in evaluating the internal resistance R of the rechargeable battery 1. FIG. 5 shows changes in values of the terminal voltage V, the temperature T, and the internal resistance R against a change in time or capacity when the rechargeable battery 1 having 12 battery cells connected in series with one another is pulse-charged with electricity from a state in which the remaining power is zero. Be noted that an on period set to 7 seconds, an off period set to 3 seconds, and a current of 0.1 C were used as the pulse charge conditions. A change width in the change characteristics of the terminal voltage V shown in FIG. 5 results from a voltage change in the on phase and off phase of the pulse charge.

As shown in FIG. 5, the value of the internal resistance R of the rechargeable battery 1 is not stable since it is large at the beginning of the charge (when the battery capacity is in the range of 0 to 30%), and also large even immediately before the full charge, i.e., even when the battery capacity is equal to or larger than 95%. On the other hand, when the battery capacity is equal to or larger than 30%, but equal to or smaller than 95%, the value of the interval resistance R of the rechargeable battery 1 is relatively stable. It is obvious from the characteristics shown in FIG. 5 that when in particular, the ratio of the battery capacity to the full battery capacity is equal to or larger than 30%, but equal to or smaller than 93%, equal to or larger than 30%, but equal to or smaller than 90%, and equal to or larger than 30%, but equal to or smaller than 85%, the stable value of the internal resistance R is obtained in this order.

Consequently, as described above, the value of the internal resistance R is obtained so as to avoid the state in which as seen at the beginning of the charge, the capacity of the rechargeable battery 1 is smaller than 30% of the capacity in the full charge phase and the state in which the capacity of the rechargeable battery 1 exceeds 95%. If the value of the internal resistance R is obtained when the battery capacity falls in the range of 30 to 85% for which the value of the internal resistance R is particularly stable, the value of the internal resistance R can be precisely obtained and evaluated without being influenced by the changes in terminal voltage V and battery temperature T.

It should be noted that the present invention is not limited to the above-mentioned embodiment. For example, it is of course possible to monitor the change itself of the value of the internal resistance R obtained in the manner as described above to judge the battery life. In addition, it is also possible that the value of the internal resistance R obtained at a time point when the value of the internal resistance R obtained in the initial phase at the start of use of the rechargeable battery 1 becomes stable is registered as a reference for the judgment of the life, and on and after that time point, the value of the internal resistance obtained at a time point of the current use is compared with the reference value of the initial resistance R to judge the life.

In addition, it is to be understood that any of the various techniques which have been conventionally proposed can be suitably adopted as the method of calculating the value of the internal resistance. Moreover, of course, the method of charging the rechargeable battery with electricity is not specified to the pulse charge method. Furthermore, the present invention can be implemented in the form of various changes without departing the gist of the invention.

What is claimed is:

1. A method of judging the life of a rechargeable battery, said rechargeable battery being used while charge and discharge are repeatedly performed therefor,
wherein when said rechargeable battery is charged with electricity, an internal resistance of said rechargeable battery is measured in a state in which a remaining power of said rechargeable battery has a predetermined capacity, and the value of the internal resistance with passage of time is obtained, thereby judging the life of said rechargeable battery based on the change of the value of the internal resistance with passage of time.

2. The method of judging the life of a rechargeable battery according to claim 1, wherein when the remaining power of said rechargeable battery during a full charge phase is set as 100%, the predetermined capacity is equal to or larger than 30%, but equal to or smaller than 93%.

3. The method of judging the life of a rechargeable battery according to claim 1, wherein when the remaining power of said rechargeable battery during a full charge phase is set as 100%, the predetermined capacity is equal to or larger than 30%, but equal to or smaller than 85%.
